(19) United States
(12) Patent Application Publication
(10) Pub. No.: US 2014/0198657 A1
(43) Pub. Date: Jul. 17, 2014

(54) METHOD, DEVICE, AND BASE STATION FOR TRANSMITTING DATA, DEVICE, AND BASE STATION

(71) Applicant: HUAWEI TECHNOLOGIES CO. LTD. ,, SHENZHEN (CN)

(72) Inventor: Jiagang JI, Shenzhen (CN)

(73) Assignee: HUAWEI TECHNOLOGIES CO. LTD. ,, SHENZHEN (CN)

(21) Appl. No.: 14/212,388

(22) Filed: Mar. 14, 2014

Related U.S. Application Data
(63) Continuation of application No. PCT/CN2011/079618, filed on Sep. 14, 2011.

(51) Int. Cl. H04W 28/08; H04W 88/08

(52) U.S. Cl. CPC H04W 28/08; H04W 88/08
USPC 370/235

(57) ABSTRACT

Embodiments of the present invention provide a method, a device, and a base station for transmitting data. The method includes: receiving, by a base station, data sent by a core network, where the data is data that needs to be sent to a terminal and the terminal is a terminal that has separately established a connection to the base station and a WiFi access point; selecting, by the base station, one of the base station and the WiFi access point according to a load of the base transceiver station and a load of the WiFi access point; sending the data to the terminal by using the selected base station or WiFi access point. By using the technical solutions according to the embodiments of the present invention, the loads of two networks is balanced and resources of the two networks are effectively used.

### CROSS-REFERENCE TO RELATED APPLICATIONS

This application is a continuation of International Application No. PCT/CN2011/079618, filed on Sep. 14, 2011, which is hereby incorporated by reference in its entirety.

### TECHNICAL FIELD

The present invention relates to the field of communication technologies, and in particular, to a method, a device, and a base station for transmitting data.

### BACKGROUND

Compared with a mobile network, a WiFi (Wireless Fidelity, wireless fidelity) network has absolute advantages of high transmission bandwidth and a low network construction cost, but has poor mobility and a limited coverage area. A CDMA (Code Division Multiple Access, Code Division Multiple Access) network, however, has good mobility and a wide coverage area, but has low transmission bandwidth and a high construction cost. The two types of networks, with their respective advantages and shortcomings, may complement each other when they are integrated, thereby forming a seamless wireless broadband solution.

In order to effectively utilize the advantages of the WiFi network and the CDMA network, a technical solution for implementing a WiFi function on a CDMA terminal is proposed in the prior art. However, because the CDMA network and the WiFi network are two networks independent of each other, a core network device cannot consider loads of an air interface of the CDMA network and an air interface of the WiFi network when sending data to the terminal, which probably results in a case in which the air interface of one network is heavily loaded but the air interface of the other network is lightly loaded so that resources cannot be used effectively.

### SUMMARY

Embodiments of the present invention provide a method, a device and a base station for transmitting data. By using technical solutions according to the embodiments of the present invention, a core network device or a base station may determine, according to a load of the base station and a load of a WiFi access point, whether the base station or the WiFi access point sends data to the terminal, thereby balancing the loads of two networks and further effectively using resources of the two networks.

A method for transmitting data provided by an embodiment of the present invention includes:
obtaining, by a core network device, data that needs to be sent to a terminal, where the terminal is a terminal that has separately established a connection to a base station and a WiFi access point; and
selecting, by the core network device, one of the base station and the WiFi access point according to a load of the base station and a load of the WiFi access point, and sending the data to the terminal by using the selected base station or WiFi access point; or sending, by the core network device, the data to the base station, so that the base station selects one of the base station and the WiFi access point according to the load of the base station and the load of the WiFi access point, and sending the data to the terminal by using the selected base station or WiFi access point.

Another method for transmitting data provided by an embodiment of the present invention includes:
receiving, by a base station, data sent by a core network device, where the data is data that needs to be sent to a terminal and the terminal is a terminal that has separately established a connection to the base station and a WiFi access point; and
selecting, by the base station, one of the base station and the WiFi access point according to a load of the base station and a load of the WiFi access point, and sending the data to the terminal by using the selected base station or WiFi access point.

An embodiment of the present invention further provides a device, where the device includes:
a first processor, configured to obtain data that needs to be sent to a terminal, where the terminal is a terminal that has separately established a connection to a base station and a WiFi access point; and
a second processor, configured to select one of the base station and the WiFi access point according to a load of the base station and a load of the WiFi access point; and
a sender, configured to send the data to the terminal by using the base station or WiFi access point that is selected by the second processor.

Besides, an embodiment of the present invention further provides a base station, where the base station includes:
a receiver, configured to receive data sent by a core network device, where the data is data that needs to be sent to a terminal and the terminal is a terminal that has separately established a connection to the base station and a WiFi access point; and
a processor, configured to select one of the base station and the WiFi access point according to a load of the base station and a load of the WiFi access point; and
a sender, configured to send the data to the terminal by using the selected base station or WiFi access point.

By using the foregoing technical solutions of the present invention, a core network device or a base station may determine, according to a load of the base station and a load of a WiFi access point, whether the base station or the WiFi access point sends data to the terminal, thereby balancing the loads of two networks and further effectively using resources of the two networks.

### BRIEF DESCRIPTION OF DRAWINGS

The following describes exemplary embodiments of the present invention with reference to accompanying drawings, so that a person of ordinary skill in the art can understand the foregoing and other characteristics and advantages of the present invention more clearly. In the accompanying drawings:

FIG. 1 is a schematic flowchart of a method for transmitting data according to Embodiment 1 of the present invention;

FIG. 2 is a schematic flowchart of a method for transmitting data according to Embodiment 2 of the present invention;

FIG. 3 is a schematic flowchart of a method for obtaining WiFi access point information according to Embodiment 3 of the present invention;

FIG. 4(a) and FIG. 4(b) are schematic diagrams of a type of data transmission according to Embodiment 4 of the present invention;

FIG. 5(a) and FIG. 5(b) are schematic diagrams of another type of data transmission according to Embodiment 4 of the present invention;

FIG. 6 is a schematic structural diagram of a device according to the present invention; and

FIG. 7 is a schematic structural diagram of a base station according to the present invention.

### DESCRIPTION OF EMBODIMENTS

To make the objectives, technical solutions, and advantages of the embodiments of the present invention clearer, the following clearly and completely describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present invention.

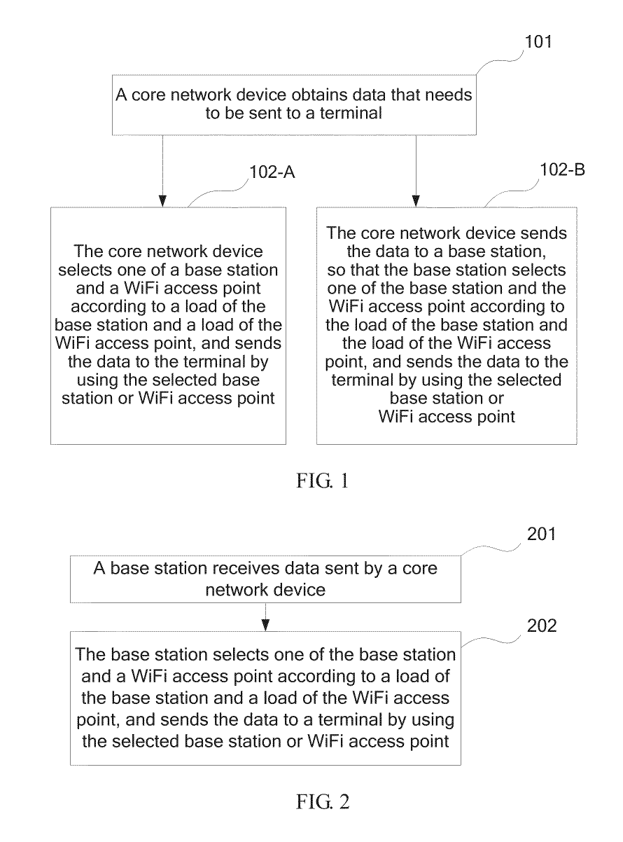

FIG. 1 is a schematic flowchart of a method for transmitting data according to Embodiment 1 of the present invention, which specifically includes the following steps:

Step 101: A core network device obtains data that needs to be sent to a terminal, where the terminal is a terminal that has separately established a connection to a base station and a WiFi access point.

Before the step 101, the core network device has separately established a connection to the base station and the WiFi access point.

Step 102-A: The core network device selects one of the base station and the WiFi access point according to a load of the base station and a load of the WiFi access point, and sends the data to the terminal by using the selected base station or WiFi access point; or

Step 102-B: The core network device sends the data to the base station, so that the base station selects one of the base station and the WiFi access point according to the load of the base station and the load of the WiFi access point, and sends the data to the terminal by using the selected base station or WiFi access point.

In the step 102 described above, after obtaining the data that needs to be sent to the terminal, the core network device may send the data to the terminal by using either of the step 102-A and the step 102-B.

The step 102-A may specifically include the following several cases:
if the load of the base station is less than the load of the WiFi access point, the core network device selects the base station and sends the data to the terminal by using the base station;
if the load of the base station is greater than the load of the WiFi access point, the core network device selects the WiFi access point and sends the data to the terminal by using the WiFi access point; and
if the load of the base station is equal to the load of the WiFi access point, the core network device selects one of the base station and the WiFi access point randomly or selects one of the base station and the WiFi access point according to a preset priority sequence, and sends the data to the terminal by using the selected base station or WiFi access point. For example, when an operator wants more data to be processed on the base station, a priority of the base station may be set, on the core network device, to be higher than a priority of the WiFi access point. After obtaining the data that needs to be sent to the terminal, the core network device may first select the base station to forward the data to the terminal Certainly, the priority of the WiFi access point may be set to be higher than the priority of the base station as required.

The core network device may be a BSC (base station controller, base station controller) or a PDSN (packet data serving node, packet data serving node).

By using the method according to Embodiment 1, a core network device may determine, according to a load of a base station and a load of a WiFi access point, a network that is used to send data to the terminal, thereby balancing the loads of two networks and further effectively using resources of the two networks.

FIG. 2 is a schematic flowchart of a method for transmitting data according to Embodiment 2 of the present invention, which specifically includes the following steps:

Step 201: A base station receives data sent by a core network device, where the data is data that needs to be sent to a terminal and the terminal is a terminal that has separately established a connection to the base station and a WiFi access point.

Step 202: The base station selects one of the base station and the WiFi access point according to a load of the base station and a load of the WiFi access point, and sends the data to the terminal by using the selected base station or WiFi access point.

For example, when the load of the base station is less than the load of the WiFi access point, the base station may opt to send the data to the terminal by using the base station itself, thereby offloading the load of the WiFi access point; when the load of the base station is greater than the load of the WiFi access point, the base station may select the WiFi access point to send the data to the terminal, thereby saving an air interface resource of the base station; and when the load of the base station is equal to the load of the WiFi access point, the base station may select one of the base station and the WiFi access point randomly or select one according to a preset priority sequence to send the data to the terminal. For example, when an operator wants more data to be processed on the base station, a priority of the base station may be set, on the base station, to be higher than a priority of the WiFi access point. After receiving data sent by a core network device, the base station may first select the base station to forward the data to the terminal. Certainly, the priority of the WiFi access point may be set to be higher than the priority of the base station as required.

By using the method according to Embodiment 2, a base station may determine, according to a load of the base station and a load of a WiFi access point, whether the base station or the WiFi access point sends data to the terminal, thereby balancing the loads of two networks and further effectively using resources of the two networks.

The following describes the technical solutions of the present invention by using a more specific embodiment.

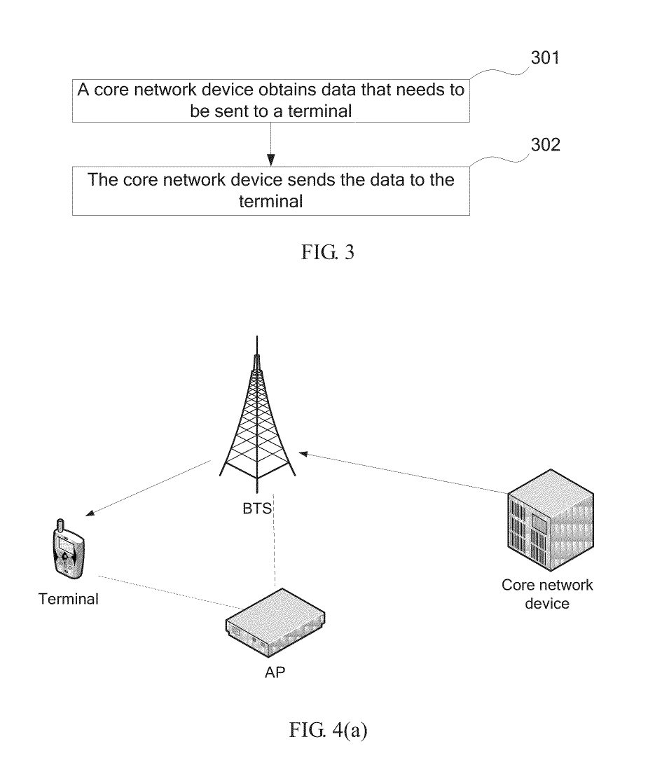

FIG. 3 is a schematic flowchart of a method for obtaining WiFi access point information according to Embodiment 3 of the present invention. In the embodiment, it is assumed that a base station is a BTS (Base Transceiver Station) in a CDMA network, a WiFi access point is an AP (Access Point), and a terminal is a dual-mode terminal that supports the CDMA network and a WiFi network. The method according to this embodiment specifically includes the following steps:

Step 301: A core network device obtains data that needs to be sent to the terminal

Before the step 301, the terminal has separately established a connection to the BTS in the CDMA network and the AP.

Step 302: The core network device sends the data to the terminal

The core network device may send the data to the terminal in either of the following two manners:

(1) The core network device sends the data to the BTS; the BTS may select one of the BTS and the AP according to a load of the BTS and a load of the AP, and send the data to the terminal by using the selected BTS or AP.

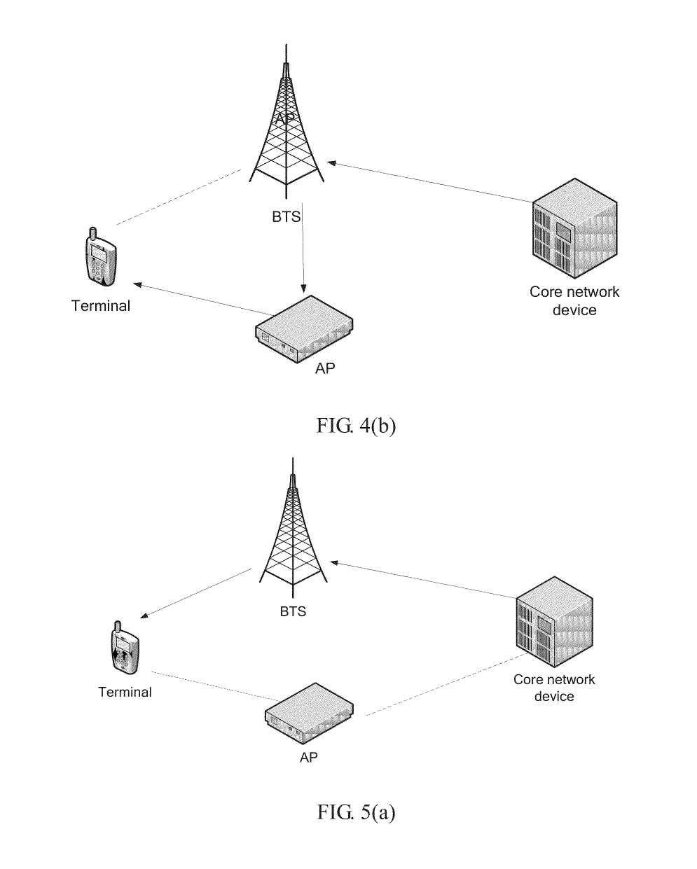

For example, refer to solid lines shown in FIG. 4(a), when the load of the BTS is less than the load of the AP, the BTS may opt to send the data to the terminal by using the BTS itself, thereby offloading the load of the AP. Refer to solid lines shown in FIG. 4(b), when the load of the BTS is greater than the load of the AP, the BTS may select the AP to send the data to the terminal, thereby saving an air interface resource of the BTS. When the load of the BTS is equal to the load of the AP, the BTS may select one of the BTS itself and the WiFi access point randomly or select one according to a preset priority sequence, so as to send the data to the terminal. For example, when an operator wants more data to be processed on the BTS, a priority of the BTS may be set, on the BTS, to be higher than a priority of the AP. After receiving the data sent by the core network device, if finding that the load of the BTS itself is equal to the load of the AP, the BTS may first select the BTS itself to forward the data to the terminal. Certainly, the priority of the AP may be set to be higher than the priority of the BTS as required.

(2) The core network device selects one of the BTS and the AP according to the load of the BTS and the load of the AP, and sends the data to the terminal by using the selected BTS or AP.

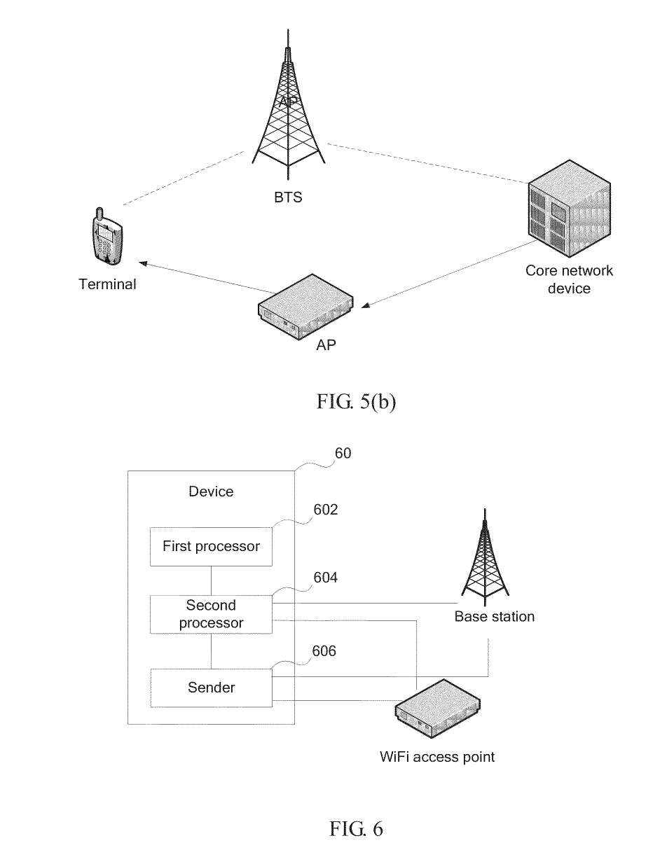

For example, refer to solid lines shown in FIG. 5(a), if the load of the BTS is less than the load of the AP, the core network device selects the BTS and sends the data to the terminal by using the BTS. Refer to solid lines shown in FIG. 5(b), if the load of the BTS is greater than the load of the AP, the core network device selects the AP and sends the data to the terminal by using the AP. If the load of the BTS is equal to the load of the AP, the core network device selects one of the BTS and the AP randomly, and sends the data to the terminal by using the selected BTS or AP. For example, when an operator wants more data to be processed on the BTS, a priority of the BTS may be set, on the core network device, to be higher than a priority of the AP. After obtaining the data that needs to be sent to the terminal, if finding that the load of the BTS is equal to the load of the AP, the core network device may first select the BTS to forward the data to the terminal. Certainly, the priority of the AP may be set to be higher than the priority of the BTS as required.

In order to enable the core network device to obtain the loads of the BTS and the AP in real time, the BTS or the AP may periodically report the load of the BTS or the AP to the core network device.

The core network device in this embodiment of the present invention may be a BSC or a PDSN.

By using the method according to Embodiment 3 of the present invention, when a core network device or a BTS forwards data to a terminal, loads of the BTS and an AP may be considered, so that air interface resources of the BTS and the AP can be effectively used.

Besides the foregoing method embodiments, referring to FIG. 6, an embodiment of the present invention further provides a device 60, where the device 60 includes:
a first processor 602, configured to obtain data that needs to be sent to a terminal, where the terminal is a terminal that has separately established a connection to a base station and a WiFi access point.
a second processor 604, configured to select one of the base station and the WiFi access point according to a load of the base station and a load of the WiFi access point; and
a sender 606, configured to send the data to the terminal by using the base station or WiFi access point that is selected by the second processor 604.

The device may further include a third processor, configured to separately establish a connection to the base station and the WiFi access point.

The second processor 604 may be specifically configured to:
select the base station if the load of the base station is less than the load of the WiFi access point;
select the WiFi access point if the load of the base station is greater than the load of the WiFi access point; and
select one of the base station and the WiFi access point randomly or select one of the base station and the WiFi access point according to a preset priority sequence if the load of the base station is equal to the load of the WiFi access point.

The device 60 may be a BSC or a PDSN.

The device 60 may be configured to perform all steps that are performed by the core network device in the method embodiment 1 to the method embodiment 3. Because the steps have been described in detail in the method embodiments, details are not described repeatedly herein.

By using the solution described in this embodiment of the present invention, a device may consider loads of a base station and a WiFi access point when forwarding data to a terminal, so that air interface resources of the base station and the WiFi access point can be effectively used.

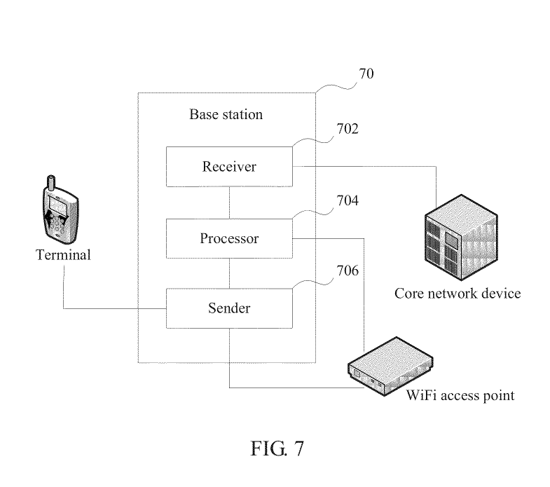

Referring to FIG. 7, an embodiment of the present invention further provides a base station 70, where the base station 70 includes:
a receiver 702, configured to receive data sent by a core network device, where the data is data that needs to be sent to a terminal and the terminal is a terminal that has separately established a connection to the base station and a WiFi access point; and
a processor 704, configured to select one of the base station and the WiFi access point according to a load of the base station and a load of the WiFi access point; and
a sender 706, configured to send the data to the terminal by using the base station or WiFi access point selected by the processor 704.

The processor 704 is specifically configured to:
select the base station if the load of the base station is less than the load of the WiFi access point;
select, by the base station, the WiFi access point if the load of the base station is greater than the load of the WiFi access point; and
select one of the base station and the WiFi access point randomly or select one of the base station and the WiFi access point according to a preset priority sequence if the load of the base station is equal to the load of the WiFi access point.

The base station 70 may be configured to perform all steps that are performed by the base station in the method embodiment 1 to the method embodiment 3. Because the steps have been described in detail in the method embodiments, details are not described repeatedly herein.

By using the method described in the foregoing embodiment, a base station may consider loads of the base station and a WiFi access point when forwarding data to a terminal, so that air interface resources of the base station and the WiFi access point can be effectively used.

A person of ordinary skill in the art may understand that all or a part of the steps of the method embodiments may be implemented by a program instructing relevant hardware. The program may be stored in a computer readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention other than limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present invention.

What is claimed is:

1. A method for transmitting data, comprising:
obtaining, by a core network device, data that needs to be sent to a terminal, wherein the terminal is a terminal that has separately established a connection to a base station and a WiFi access point; and
selecting, by the core network device, one of the base station and the WiFi access point according to a load of the base station and a load of the WiFi access point, and sending the data to the terminal by using the selected base station or WiFi access point; or sending, by the core network device, the data to the base station, so that the base station selects one of the base station and the WiFi access point according to the load of the base station and the load of the WiFi access point, and sending the data to the terminal by using the selected base station or WiFi access point.

2. The method according to claim 1, comprising:
separately establishing, by the core network device, a connection to the base station and the WiFi access point.

3. The method according to claim 1, wherein the selecting, by the core network device, one of the base station and the WiFi access point according to a load of the base station and a load of the WiFi access point comprises:
selecting, by the core network device, the base station if the load of the base station is less than the load of the WiFi access point;
selecting, by the core network device, the WiFi access point if the load of the base station is greater than the load of the WiFi access point; and
selecting, by the core network device, one of the base station and the WiFi access point randomly or selecting one of the base station and the WiFi access point according to a preset priority sequence if the load of the base station is equal to the load of the WiFi access point.

4. The method according to claim 1, wherein the core network device is a base station controller or a packet data serving node.

5. A method for transmitting data, comprising:
receiving, by a base station, data sent by a core network device, wherein the data is data that needs to be sent to a terminal and the terminal is a terminal that has separately established a connection to the base station and a WiFi access point; and
selecting, by the base station, one of the base station and the WiFi access point according to a load of the base station and a load of the WiFi access point, and sending the data to the terminal by using the selected base station or WiFi access point.

6. The method according to claim 5, wherein the selecting, by the base station, one of the base station and the WiFi access point according to a load of the base transceiver station and a load of the WiFi access point comprises:
selecting the base station if the load of the base station is less than the load of the WiFi access point;
selecting, by the base station, the WiFi access point if the load of the base station is greater than the load of the WiFi access point; and
selecting one of the base station and the WiFi access point randomly or selecting one of the base station and the WiFi access point according to a preset priority sequence if the load of the base station is equal to the load of the WiFi access point.

7. A device, comprising:
a first processor, configured to obtain data that needs to be sent to a terminal, wherein the terminal is a terminal that has separately established a connection to a base station and a WiFi access point; and
a second processor, configured to select one of the base station and the WiFi access point according to a load of the base station and a load of the WiFi access point; and
a sender, configured to send the data to the terminal by using the base station or WiFi access point that is selected by the second processor.

8. The device according to claim 7, comprising:
a third processor, configured to separately establish a connection with the base station and the WiFi access point.

9. The device according to claim 7, wherein the second processor is specifically configured to:
select the base station if the load of the base station is less than the load of the WiFi access point;
select the WiFi access point if the load of the base station is greater than the load of the WiFi access point; and
select one of the base station and the WiFi access point randomly or select one of the base station and the WiFi access point according to a preset priority sequence if the load of the base station is equal to the load of the WiFi access point.

10. The device according to claim 7, wherein the device is a base station controller or a packet data serving node.

11. A base station, comprising:
a receiver, configured to receive data sent by a core network device, wherein the data is data that needs to be sent to a terminal and the terminal is a terminal that has separately established a connection to the base station and a WiFi access point;
a processor, configured to select one of the base station and the WiFi access point according to a load of the base station and a load of the WiFi access point; and
a sender, configured to send the data to the terminal by using the selected base station or WiFi access point.

12. The base station according to claim 11, wherein the processor is specifically configured to:
select the base station if the load of the base station is less than the load of the WiFi access point;
select, by the base station, the WiFi access point if the load of the base station is greater than the load of the WiFi access point; and
select one of the base station and the WiFi access point randomly or select one of the base station and the WiFi access point according to a preset priority sequence if the load of the base station is equal to the load of the WiFi access point.
